(19) United States
(12) Patent Application Publication
(10) Pub. No.: US 2011/0225499 A1
(43) Pub. Date: Sep. 15, 2011

(54) NETWORK DEVICE

(75) Inventor: Yi-Jen Lu, Hukou (TW)

(73) Assignee: GEMTEK TECHNOLOGY CO., LTD., Hukou (TW)

(21) Appl. No.: 12/787,856

(22) Filed: May 26, 2010

(30) Foreign Application Priority Data
Mar. 9, 2010 (TW) 099106761

(51) Int. Cl. G06F 3/01; G06F 15/177

(52) U.S. Cl. 715/735

(57) ABSTRACT

A network device includes a Universal Serial Bus (USB) port adapted for connecting to a USB connector of a wireless network module, and a Linux-based embedded system that includes a user interface unit, a data converting unit, and a driver unit. The user interface is for providing a user interface to a user terminal and for user input of configuration data for the wireless network module through the user terminal. The user interface unit receives the inputted configuration data from the user terminal. The data converting unit is coupled to the user interface unit for receiving the configuration data therefrom and for converting the configuration data into at least one command. The driver unit is coupled between the data converting unit and the USB port for transferring the at least one command from the data converting unit to the wireless network module.

### CROSS-REFERENCE TO RELATED APPLICATION

This application claims priority of Taiwanese Application No. 099106761, filed on Mar. 9, 2010.

### BACKGROUND OF THE INVENTION

1. Field of the Invention

The present invention relates to a network device, more particularly to a network device adapted for use with a wireless network module that has a universal serial bus (USB) connector, and having a Linux-based embedded system.

2. Description of the Related Art

FIG. 1 shows a typical network topology, in which a group of user equipments 3 is connected to the Internet 4 via a network device 1 and a remote network equipment 2.

Nowadays, the network device 1 is generally implemented as a wireless router or a wireless access point that has at least one Universal Serial Bus (USB) port for connecting to a wireless network module with a USB connector (i.e., a USB dongle). The wireless network module enables the network device 1 to connect wirelessly to the Internet 4 through one of the various wireless technologies, such as Wideband Code Division Multiple Access (WCDMA) and Worldwide Interoperability for Microwave Access (WIMAX).

However, most wireless network modules have drivers that only support Windows-based embedded systems. Therefore, if the network device 1 has a Linux-based embedded system, it will not be able to communicate with the wireless network module.

### SUMMARY OF THE INVENTION

Therefore, an object of the present invention is to provide a network device adapted for use with a user terminal and a wireless network module that has a universal serial bus (USB) connector. The network device includes a USB port and a Linux-based embedded system that includes a user interface unit, a data converting unit, and a driver unit. The USB port is adapted for connecting to the wireless network module via the USB connector of the wireless network module. The Linux-based embedded system is coupled to the USB port, and includes a user interface unit, a data converting unit, and a driver unit. The user interface unit is for providing a user interface to the user terminal. The user interface is for user input of configuration data for the wireless network module through the user terminal .

The user interface unit receives the inputted configuration data from the user terminal. The data converting unit is coupled to the user interface unit for receiving the configuration data therefrom and for converting the configuration data into at least one command. The driver unit is coupled to the data converting unit for transferring the at least one command from the data converting unit to the wireless network module.

Preferably, the at least one command is a Hayes command.

Preferably, the configuration data includes subscriber identity module (SIM) personal identification number (PIN) data.

Preferably, the configuration data further includes network dialup data.

Preferably, the network device is one of a router and an access point.

The network device of the present invention is capable of communicating with and driving operation of the wireless network module, and provides the user interface to the user terminal for user input of the configuration data and for presentation of the connection status.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram illustrating a network device in an exemplary network topology;

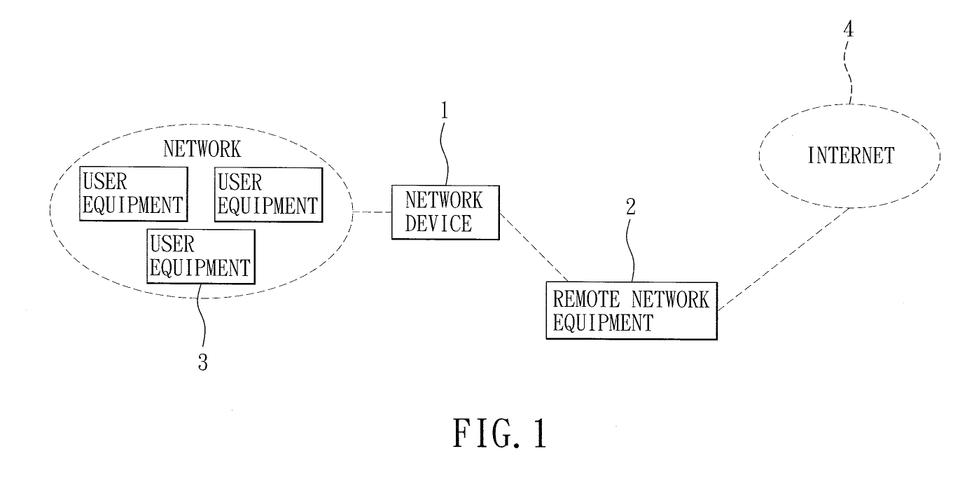

FIG. 2 is an internal functional block diagram of the preferred embodiment of a network device according to the present invention;

FIG. 3 is a screenshot of a user interface provided to a user terminal by a user interface unit of the network device, the user interface prompting a user of the user terminal to input a Personal Identification Number (PIN) in a first dialogue box; and

FIG. 4 is another screenshot of the user interface, the user interface prompting the user to enter dialup information and showing the connection status of the network device in a second dialogue box.

### DETAILED DESCRIPTION OF THE PREFERRED EMBODIMENT

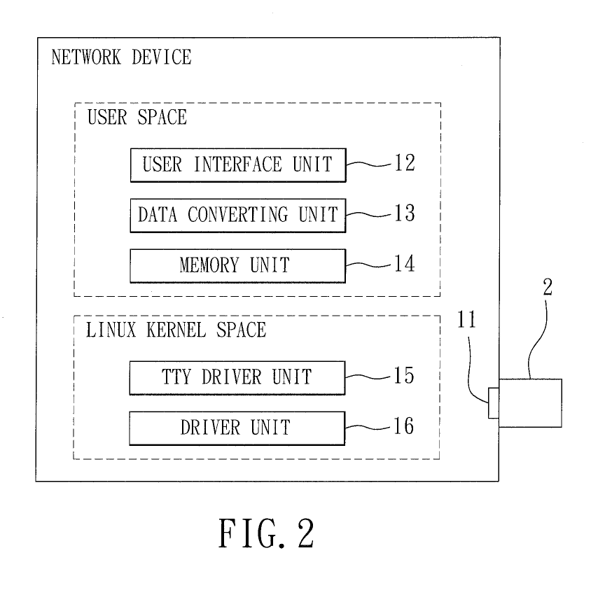

Referring to FIG. 2, the preferred embodiment of a network device 10, which may be a router or an access point, of this invention has a Linux-based embedded system including a user space and a Linux kernel space, and includes a Universal Serial Bus (USB) port 11 to be connected to a USB connector of a wireless network module 2. The user space includes a user interface unit 12, a data converting unit 13, and a memory unit 14. The Linux kernel space includes a teletype (tty) driver unit 15 and a driver unit 16. It is to be noted that the tty driver unit 15 is the driver provided by the kernel of the Linux-based embedded system, and will not be described hereinafter.

The user interface unit 12 is for providing a user interface to a user terminal, and is for user input of at least one set of configuration data for the wireless network module 2 through the user terminal. The data converting unit 13 is coupled to the user interface unit 12 for receiving the set of configuration data therefrom, converts the set of configuration data into at least one command, and provides the command to the wireless network module 2 via the tty driver unit 15 and the driver unit 16. In the present embodiment, the command is a Hayes command, which is also known as an attention (AT) command and is commonly used for communicating with a modulator-demodulator (modem).

The wireless network module 2 executes the received command and writes the execution result to the memory unit 14 via the tty driver unit 15 and the driver unit 16, e.g., writing user-defined variables to the memory unit 14.

Thus, the network device 10 is capable of communicating with the wireless network module 2.

It is to be noted that the currently available Linux kernel does not includes a driver for driving operation of the wireless network module 2. The driver unit 16 of the present invention is obtained through modifying the USB-serial driver provided by the currently available Linux kernel so as to add support for the wireless network module 2. To add support for different models and types of wireless network modules manufactured by different manufacturers that have at least one USB connector, one can modify a supported device recognition file in the memory unit 14 so as to add relevant parameters corresponding to the new wireless network modules to be added without the need to modify the driver unit 16. Specifically, the vendor identification (VID) and the product identification (PID) of a specific wireless network module can be entered into the supported device recognition file for adding support for the specific wireless network module.

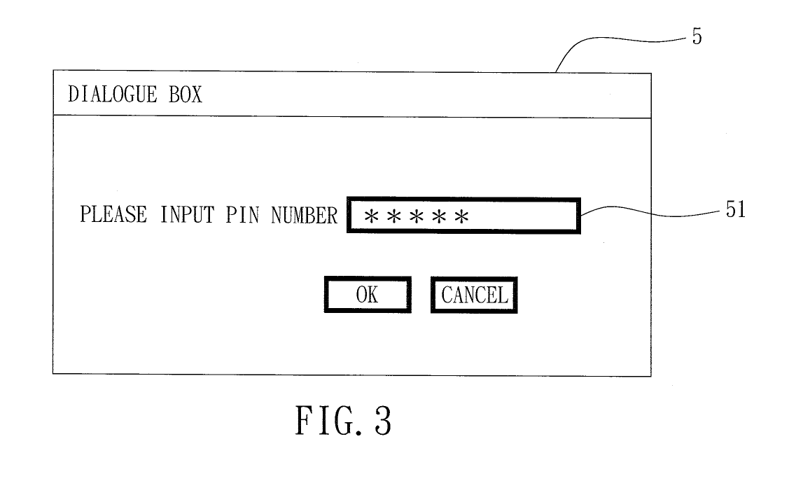

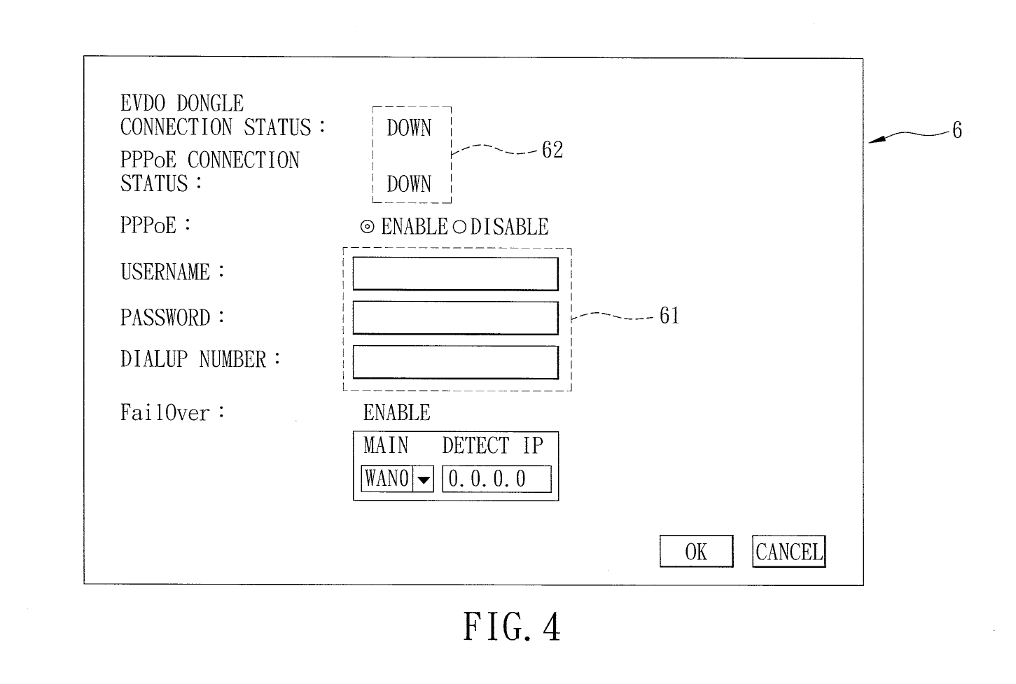

The user interface provided by the user interface unit 12 is described hereinafter with reference to FIGS. 3 and 4. In the present embodiment, the user interface is a graphical user interface (GUI).

Referring to FIG. 3, the user interface unit 12 provides a first dialogue box 5 to the user terminal so as to prompt a user of the user terminal to enter a personal identification number (PIN) of a subscriber identitymodule (SIM) , that is inserted into the wireless network module 2, in a PIN input field 51. It is to be noted that the PIN contributes to the set of configuration data.

Referring to FIG. 4, the user interface unit 12 further provides a second dialogue box 6 to the user terminal for prompting the user to enter a username, a password, and a dialup number in a set of input fields 61, and for showing the connection status 62 of the wireless network module 2. It is to be noted that the username, the password, and the dialup number also contribute to the set of configuration data.

The set of configuration data is converted into at least one Hayes command, which is subsequently provided to the wireless network module 2. The wireless network module 2 executes the received Hayes command and writes the execution result to the memory unit 14. Next, the user may cause the user interface unit 12 to access the memory unit 14 and enable presentation of the execution result, i.e., the connection status 62 shown in the second dialogue box 6.

In summary, the network device 10 of the present invention is capable of communicating with and driving operation of the wireless network module 2, and provides the user interface to the user terminal for user input of the configuration data and for indication of the connection status.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A network device adapted for use with a user terminal and a wireless network module that has a universal serial bus (USB) connector, said network device comprising:
a USB port adapted for connecting to the wireless network module via the USB connector of the wireless network module; and
a Linux-based embedded system coupled to said USB port, including
a user interface unit for providing a user interface to the user terminal, the user interface being for user input of configuration data for the wireless network module through the user terminal, said user interface unit receiving the inputted configuration data from the user terminal;
a data converting unit coupled to said user interface unit for receiving the configuration data therefrom and for converting the configuration data into at least one command; and
a driver unit coupled to said data converting unit for transferring said at least one command from said data converting unit to the wireless network module.

2. The network device as claimed in claim 1, wherein said at least one command is a Hayes command.

3. The network device as claimed in claim 1, wherein the configuration data includes subscriber identity module (SIM) personal identification number (PIN) data.

4. The network device as claimed in claim 3, wherein the configuration data further includes network dialup data.

5. The network device as claimed in claim 1, wherein said network device is one of a router and an access point.
